(19) United States
(12) Patent Application Publication
(10) Pub. No.: US 2018/0004549 A1
(43) Pub. Date: Jan. 4, 2018

(54) COMPUTER SYSTEM AND METHOD FOR CONTROLLING OPERATING FREQUENCY OF PROCESSOR

(71) Applicants: INVENTEC (PUDONG) TECHNOLOGY CORPORATION, Shanghai City (CN); INVENTEC CORPORATION, Taipei City (TW)

(72) Inventor: Ying-Xian HAN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/225,645

(22) Filed: Aug. 1, 2016

(30) Foreign Application Priority Data
Jul. 1, 2016 (CN) 201610512876.3

(51) Int. Cl. G06F 9/445; G06F 1/28

(52) U.S. Cl. CPC G06F 9/44505; G06F 1/28

(57) ABSTRACT

A computer system including a PCH (platform controller hub), a CPLD (complex programmable logic device), a first switch and a processor, and a control method are provided to control the operation frequency of the processor. The CPLD is coupled to the PCH and the first switch. The processor is coupled to the first switch. The PCH produces and outputs a second control signal according to the first firmware and a first control signal from a command input unit. The CPLD produces and outputs a third control signal according to the second firmware and the second control signal. The first switch receives the third control signal and is turned on to output a triggering signal when the third control signal is valid. The processor includes a PROCHOT pin. The processor receives the triggering signal and triggers the PROCHOT pin for frequency control.

### CROSS-REFERENCE TO RELATED APPLICATIONS

This non-provisional application claims priority under 35 U.S.C. §119(a) on Patent Application No(s). 201610512876.3 filed in China on Jul. 1, 2016, the entire contents of which are hereby incorporated by reference.

### BACKGROUND

### Technical Field

The disclosure relates to a computer system and a method for controlling the operating frequency of a processor, more particularly to a computer system and a method for triggering the processor to adjust its operating frequency.

### Related Art

A typical server usually has a complete case, a power source, one or more motherboards, one or more storage equipment, or other standard components. In addition to these components, a typical server usually has a main chip related to a processor. This main chip functions as the computing core of the server. Testing processors is very important, and testing the switching of processor frequency is a crucial test item. In the past, testing the switching of processor frequency is usually carried out by directly providing a preset environment, where the processor is heated directly by a heat gun in an example, and then by checking whether the processor is able to switch its operating frequency, so as to analyze the performance of the processor. This manner relies heavily on personnel during a test task. On the other hand, modern servers have a tendency to not dispose any baseboard management board (BMC), so it is important to trigger the frequency control without any BMC.

### SUMMARY

According to one or more embodiments, a computer system of controlling the operating frequency of a processor includes a platform controller hub, a complex programmable logic device, a first switch and the processor. The platform controller hub is coupled to the complex programmable logic device, the first switch is coupled to the complex programmable logic device, and the processor is coupled to the first switch. The platform controller hub receives a first control signal from a command input unit, e.g. an external command input device. The platform controller hub generates and outputs a second control signal according to the first firmware and the first control signal. The complex programmable logic device receives the second control signal. The complex programmable logic device generates and outputs a third control signal according to the second firmware and the second control signal. The first switch receives the third control signal. When the third control signal is valid, the first switch is turned on to output a triggering signal. The processor includes a PROCHOT pin. The processor receives the triggering signal to trigger the PROCHOT pin for frequency control.

According to one or more embodiments, a method of controlling the operating frequency of a processor includes steps of: providing a first control signal to a platform controller hub and making the platform controller hub receive the first control signal and generate and output a second control signal according to the first firmware and the first control signal; making a complex programmable logic device receive the second control signal and generate and output a third control signal according to the second firmware and the second control signal; making a first switch receive the third control signal, and determining whether the third control signal is valid, wherein when the third control signal is valid, the first switch is turned on to output a triggering signal; and making a PROCHOT pin of the processor receive the triggering signal so that the PROCHOT pin is triggered for frequency control.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a computer system of controlling the operating frequency of a processor in the disclosure;

FIG. 2 is a schematic circuit diagram of a fraction of the computer system; and

FIG. 3 is a flow chart of a method of controlling the operating frequency of a processor.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

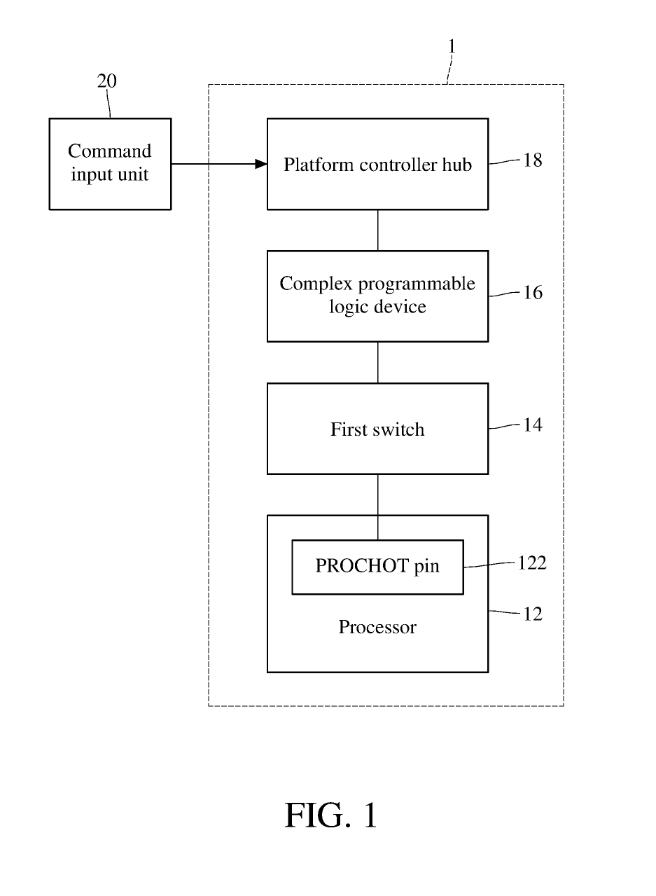

Please refer to FIG. 1. FIG. 1 is a block diagram of a computer system of controlling the operating frequency of a processor in the disclosure. The disclosure provides a computer system 1 capable of controlling the operating frequency of a processor. The computer system 1 includes a platform controller hub (PCH) 18, a complex programmable logic device (CPLD) 16, a first switch 14 and a processor 12. The platform controller hub 18 is coupled to the complex programmable logic device 16, the first switch 14 is coupled to the complex programmable logic device 16, and the processor 12 is coupled to the first switch 14. The processor 12 includes a PROCHOT pin 122.

The platform controller hub 18 receives a first control signal of a command input unit 20. The platform controller hub 18 has first firmware in which one or more commands related to the first control signal are stored. When the platform controller hub 18 receives the first control signal, the platform controller hub 18 will generate and output a second control signal according to the first control signal and the first firmware. In an embodiment, the command input unit 20 is not limited to, for example, be pluggable and coupled to the platform controller hub 18.

The complex programmable logic device 16 is coupled to the platform controller hub 18 by, for example, a serial general purpose input output (SGPIO) interface. When the complex programmable logic device 16 receives the second control signal (i.e. a SGPIO signal), the complex programmable logic device 16 will generate and output a third control signal according to the second control signal and second firmware. In the second firmware, one or more commands related to the second control signal are stored. In an embodiment, the second firmware includes a logical expression and determines whether the message carried by the second control signal matches one or more determination conditions in the logical expression, so as to generate a third control signal. In an embodiment, the second control signal indicates the monitoring result of the temperature of at least one component on a motherboard, for example. That is, the second control signal is used to indicate whether the temperature of at least one related component is too high. Therefore, the user can control one or more related fields or bit segments in the second control signal by providing the first control signal to the platform controller hub 18, so as to simulate the situation that the temperature of the at least one component is too high. In an interpretation, said one or more determination conditions for the at least one component are used to determine whether the temperature of the at least one component is too high, or determine the occurrence of other error situations. The logical expression can be freely designed by a person of ordinary skill in the art, and is not limited by the above example.

The processor 12 has the PROCHOT pin. The processor 12 receives a triggering signal via the PROCHOT pin to carry out frequency control. The first switch 14 is coupled to the complex programmable logic device 16 and the PROCHOT pin 122 of the processor 12. When the third control signal is a valid signal, the first switch 14 will be turned on to output the triggering signal to the PROCHOT pin, so that the processor 12 is triggered by the PROCHOT pin 122 to adjust the operating frequency for frequency control. In an embodiment, when the third control signal is a valid signal, the first switch 14 will be turned on so that the PROCHOT pin 122 of the processor 12 will be at a low voltage potential or be coupled to the ground end. In practice, the first switch 14 is not limited to, for example, a NPN type bipolar junction transistor (BJT) or a PNP type BJT. For a concise description, the following embodiments are based on the case of the first switch 14 including a first end, a second end and a control end. In an embodiment, the third control signal is, for example, a voltage potential signal and is provided to the control end of the first switch 14, and when the third control signal is at a relatively low voltage potential, the first switch 14 will be turned on by the complex programmable logic device 16. In practice, the first end, second end and control end of the first switch 14 can further be coupled to one or more resistors or other electric components to achieve better performance, and the disclosure is not limited thereto.

In an embodiment, a user can use the command input unit 20 to easily input one or more commands into the computer system 1, so as to control the operating frequency of the processor 12. For example, the command input unit 20 is not limited to a computer or server capable of running a Windows OS or Linux OS. First, the OS releases a channel of the SGPIO interface between the platform controller hub 18 and the complex programmable logic device 16. This channel is not limited to SGPIO_SATA_LOAD. In an embodiment, the default value of this channel is a high voltage potential that depends on the application standard and is not limited. When the platform controller hub 18 receives the first control signal, the platform controller hub 18 will generate and output the second control signal to the SGPIO channel according to the first control signal and the first firmware.

Additionally, there is an instruction statement related to such a SGPIO channel in the second firmware of the complex programmable logic device 16. In other words, the second firmware of the complex programmable logic device 16 includes the second control command so that when the complex programmable logic device 16 receives the second control signal from the above channel, the complex programmable logic device 16 will generate the third control signal according to the second control signal and the related command in the second firmware. In an embodiment, when the first control signal indicates that the operating frequency of the processor 12 should be decreased, the third control signal will be at a low voltage potential.

For this, the control statement or instruction related to each component is exemplified as follows and is used to limit available implementations in practice.

In an embodiment, a GPIO channel permitting the communication between the platform controller hub (i.e. pin: GPP_F11) and the complex programmable logic device (i.e. pin: SGPIO_SATA_LOAD) is provided, and this channel is valid as being at a low voltage potential. In this case, the register related to the GPIO channel in the platform controller hub is 0xfdae640, and the target port ID of the output pin is 0xAE.F6.

In an exemplary embodiment, when the user can input one or more commands via the Windows OS, the first control signal related to the one or more commands is provided to the platform controller hub 18, so as to trigger the processor to reduce its operating frequency or restore its operating frequency to the default value. For example, it is assumed that a command (1) for triggering the processor to reduce its operating frequency is GPIO Setting enable and a command (2) for triggering the processor to restore its operating frequency to a default value is GPIO Setting default; and thus, the PCH execution instruction is “clear bit 0 of 0xfdae0640” resulting in a low GPIO potential when the command (1) is received, the PCH execution instruction is “set bit0 of 0xfdae0640” resulting in a high GPIO potential when the command (2) is received.

Particularly, the following example is taken to explain how the first firmware pulls down the GPIO potential when the platform controller hub 18 receives the command (1). If the offset of 0xAE.F6 is 0x618, the address of 0xAE.F6 is Address=(SBREG)|(0xAE<<16)|(0x618), which means that 0x80000201 is written into Address space; and if GPP_F11 is set as low output, the offset of 0xAE. F6 is 0x61C, the address of 0xAE. F6 is Address=(SBREG)|(0xAE<<16)|(0x61C), which means that 0x00000000 is written into Address space. Based on the above settings, the control statement related to the GPIO read and writing in the platform controller hub 18 includes:
“unsigned long long addressCtrl=(address)|(0xAE<<16)|(0x618);
setMemLong32(addressCtrl,0x80000201);
unsigned int outputValue=0;
unsigned long long addressData=address|(0xAE<<16)|(0x61C);
setMemLong32(addressData,outputValue);”.

After the above statement is executed, the result of executing the content of Address space is 0xfd000000, which leads to a low potential as the output of the platform controller hub 18, and the related low potential signal is sent to complex programmable logic device via the SGPIO.

Accordingly, after the complex programmable logic device receives the above low potential signal of SGPIO, the instruction “assign PAL_CPU_PROCHOT=FM_SLPS0 N ? (˜YR PVCC CPU VR HOT N)|(˜CPU dimm event co n)|(˜SGPIO_SATA_LOAD)” pre-stored in the second firmware is executed to generate a potential signal as a result.

The output end of the complex programmable logic device is connected to the pin PAL_CPU_PROCHOT of the processor, so that when such a potential signal is valid, the pin PAL_CPU_PROCHOT will be triggered, so as to carry out processor down-clocking, also known as processor under-clocking.

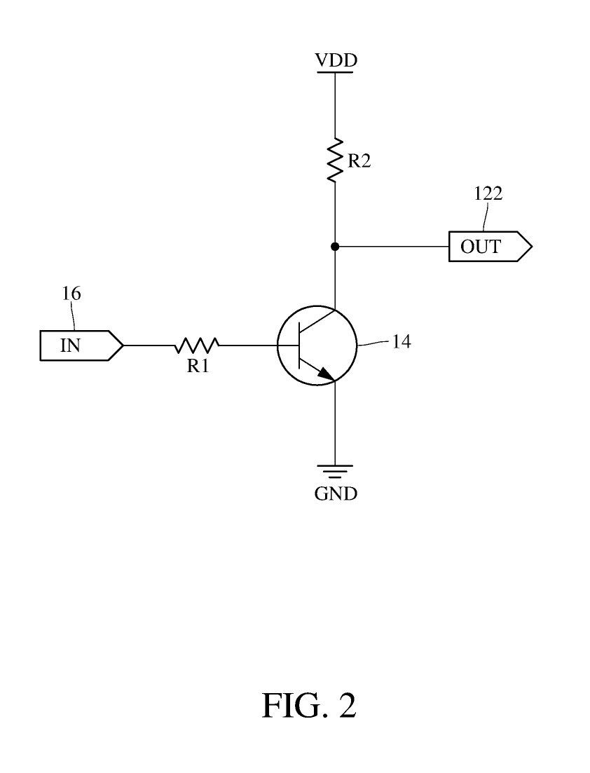

Please refer to FIG. 2 to illustrate the connections between the complex programmable logic device, the first switch and the PROCHOT pin of the processor. FIG. 2 is a schematic circuit diagram of a fraction of the computer system. As described above, the first switch 14 is, for example, a NPN type BJT. The control end of the first switch 14 receives the third control signal provided by the complex programmable logic device 16. In one or more examples, the PROCHOT pin 122 of the processor 12 is coupled to the first end of the first switch 14, the second end of the first switch 14 is coupled to a node of a low voltage potential or the ground end. In this circuit structure, the PROCHOT pin 122 of the processor 12 is predeterminedly at a high voltage potential. When the third control signal is at a relatively high voltage potential, the PROCHOT pin 122 of the processor 12 is coupled to a node of a low voltage potential or the ground end so that the processor 12 is triggered to downclock. The first switch 14 is not limited to a NPN type BJT, a PNP type BJT, an N-MOS transistor or a P-MOS transistor. After reading the disclosure, a person of ordinary skill in the art can deduced by analogy to freely define the relative values of reference voltages, and the disclosure is not limited to the above exemplary potentials.

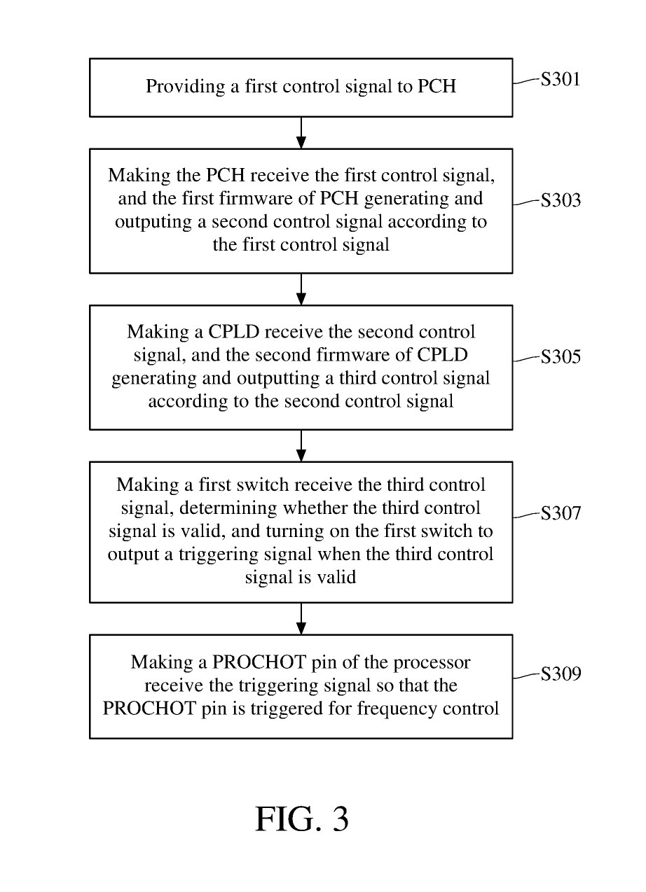

In view of the foregoing concept, the disclosure further provides a method of controlling the operating frequency of a processor. Please refer to FIG. 3. FIG. 3 is a flow chart of a method of controlling the operating frequency of a processor. In step S301, a first control signal is provided to the platform controller hub. Next, in step S303, the platform controller hub is commanded to receive the first control signal, and the first firmware of the platform controller hub generates and outputs the second control signal according to the execution of the first control signal. Also, in step S305, the complex programmable logic device is commanded to receive the second control signal, the second firmware of the complex programmable logic device generates and outputs the third control signal according to the execution of the second control signal. Then, in step S307, the third control signal is applied to the first switch, and the determination of whether the third control signal is valid is made. If yes, the first switch will be turned on, so as to output the triggering signal. Finally, in step S309, the third control signal is applied to the first switch, and the determination of whether the third control signal is valid is made. If yes, the first switch will be turned on, so as to output the triggering signal.

To sum up, the disclosure provides a computer system and a method of controlling the operating frequency of a processor, to employ the complex programmable logic device to selectively trigger the processor through the PROCHOT pin of the processor, so as to control the operating frequency of the processor. Therefore, the operating frequency can be controlled without any baseboard management controller (BMC) by directly triggering the processor. On the other hand, the platform controller hub is employed to drive the complex programmable logic device, so the user can directly command the processor to control the operating frequency of the processor by the OS, such as the Windows OS or the Linux OS, run on a computer and working in coordination with the computer system and method provided in the disclosure. In addition, such a new control method can be applied to the testing field for the great enhancement of the test efficiency of related test items, so the disclosure is practical.

What is claimed is:

1. A computer system of controlling a operating frequency of a processor, comprising:
a platform controller hub configured to receive a first control signal of a command input unit, and generate and output a second control signal according to first firmware and the first control signal;
a complex programmable logic device coupled to the platform controller hub and configured to receive the second control signal and generate and output a third control signal according to second firmware and the second control signal;
a first switch coupled to the complex programmable logic device and configured to receive the third control signal, and be turned on to output a triggering signal when the third control signal is a valid signal; and
the processor comprising a PROCHOT pin, the processor coupled to the first switch and configured to receive the triggering signal to trigger the PROCHOT pin to carry out frequency control.

2. The computer system according to claim 1, wherein the first switch comprises a first end, a second end and a control end, the first end is coupled to a ground end, the second end is coupled to the PROCHOT pin, and the control end is coupled to the complex programmable logic device.

3. The computer system according to claim 1, wherein the third control signal is a voltage potential signal, and when the voltage potential signal is low, the complex programmable logic device turns on the first switch.

4. The computer system according to claim 1, wherein the command input unit is an external command input device that is pluggable and coupled to the platform controller hub.

5. The computer system according to claim 1, wherein the second control signal is a SGPIO signal, the second firmware comprises a second control command that is executable according to the second control signal to generate and output the third control signal.

6. The computer system according to claim 1, wherein the PROCHOT pin is predeterminedly at a high voltage potential.

7. A method of controlling a operating frequency of a processor, comprising:
providing a first control signal to a platform controller hub;
making the platform controller hub receive the first control signal and generate and output a second control signal according to first firmware and the first control signal;
making a complex programmable logic device receive the second control signal and generate and output a third control signal according to second firmware and the second control signal;
making a first switch receive the third control signal, and determining whether the third control signal is valid, and turning on the first switch to output a triggering signal when the third control signal is valid; and
making a PROCHOT pin of the processor receive the triggering signal so that the PROCHOT pin is triggered to carry out frequency control.

8. The method according to claim 7, wherein the third control signal is a voltage potential signal, and when the voltage potential signal is low, the first switch is turned on by the complex programmable logic device.

9. The method according to claim 7, wherein the second control signal is a SGPIO signal, the second firmware comprises a second control command, and the third control signal is generate and outputted when the second control command is executed according to the second control signal.

10. The method according to claim 7, wherein the PROCHOT pin is predeterminedly at a high voltage potential.
